(19) United States
(12) Patent Application Publication
(10) Pub. No.: US 2024/0306790 A1
(43) Pub. Date: Sep. 19, 2024

(54) GEL NAIL DEVICE, AND GEL NAIL REMOVAL METHOD

(71) Applicant: Panasonic Intellectual Property Management Co., Ltd., Osaka (JP)

(72) Inventors: Keitaro AMARI, Kyoto (JP); Shinsuke KAWAGUCHI, Shiga (JP); Taiki UMEMOTO, Shiga (JP); Tomoko KAWASHIMA, Osaka (JP); Yuko TANIIKE, Osaka (JP); Haruka KUSUKAME, Nara (JP); Toshiyuki KOMATSU, Kyoto (JP)

(21) Appl. No.: 18/263,089

(22) PCT Filed: Jan. 31, 2022
(86) PCT No.: PCT/JP2022/003568

§ 371 Date: Jul. 26, 2023

(30) Foreign Application Priority Data
Feb. 4, 2021 (JP) 2021-016943

(51) Int. Cl. A45D 29/00; G06T 7/11

(52) U.S. Cl. CPC A45D 29/007; G06T 7/11; G06T 2207/20081

(57) ABSTRACT

Gel nail device includes: stimulus generator for applying an external stimulus for reducing an adhesion strength between gel nail and nail to at least one of gel nail or nail; sensor for detecting at least one item selected from the group consisting of a position of gel nail, a state of gel nail, a position of nail, and a state of nail; and control circuit for controlling stimulus generator based on a detection result from sensor.

### TECHNICAL FIELD

The present disclosure relates to a gel nail device and a gel nail removal method.

### BACKGROUND ART

Gel nails have characteristics such as high durability and excellent design, and have become mainstream of recent nail art. As described in PTL 1, first, a base coat agent is applied to a nail of a subject in gel nail treatment. Next, the base coat agent is irradiated with ultraviolet light, and the base coat agent is cured. Then, a color gel is applied onto the base coat agent in a desired design, and various decorations such as stones are garnished. Finally, the top coat agent is applied, and the gel nail treatment is completed.

Examples of a method for removing the gel nail from the nail include the method physically removing the gel nail using a polishing device, the method removing the gel nail using an organic solvent, and the method combining these methods. PTL 2 describes a nail machine for efficiently removing the gel nail by polishing. PTL 3 describes a nail art kit including a removal liquid that can shorten removal time and has little influence on the nail and skin.

### CITATION LIST

### Patent Literature

PTL 1: Unexamined Japanese Patent Publication No. 2013-248034
PTL 2: Japanese Utility Model Registration No. 3186710
PTL 3: Unexamined Japanese Patent Publication No. 2017-141187

### SUMMARY OF THE INVENTION

It takes a lot of time and effort to perform the gel nail treatment, particularly to remove a gel nail from a nail.

The present disclosure provides a technique being useful for the removal of the gel nail.

The present disclosure provides a gel nail device including: a stimulus generator applying an external stimulus for reducing an adhesion strength between the gel nail and the nail to at least one of the gel nail or the nail; a sensor detecting at least one item selected from the group consisting of a position of the gel nail, a state of the gel nail, a position of the nail, and a state of the nail; and a control circuit controlling the stimulus generator based on a detection result from the sensor.

In another aspect, the present disclosure provides a method for removing the gel nail from the nail including the sequential steps of: acquiring nail data of at least one item selected from the group consisting of the position of the gel nail, the state of the gel nail, the position of the nail, and the state of the nail; referring the nail data and applying the external stimulus for reducing the adhesion strength between the gel nail and the nail to at least one of the gel nail and the nail; and removing the gel nail from the nail.

The technique in the present disclosure is useful for removing the gel nail.

### BRIEF DESCRIPTION OF THE DRAWINGS

FIG. 1 is a configuration diagram of a gel nail device according to an exemplary embodiment.

FIG. 2 is a schematic cross-sectional view for explaining a principle of reduction in an adhesion strength between a gel nail and a nail.

FIG. 3 is a diagram illustrating a method of generating a mask image used to control a mask.

FIG. 4 is a diagram illustrating light irradiation using the mask.

FIG. 5 is a configuration diagram of a light source as a stimulus generator.

FIG. 6A is a perspective view of a housing of the gel nail device.

FIG. 6B is a perspective view of a housing lower portion and a cartridge.

FIG. 7 is a diagram illustrating an appearance of a treatment using the gel nail device.

### DESCRIPTION OF EMBODIMENT

### Knowledge and the Like Underlying the Present Disclosure

A method for removing a gel nail with a polishing tool includes polishing the gel nail physically. Therefore, this method has problems that time of 30 minutes or more is required, large load is burdened to a nail of a subject, not only the gel nail but also the nail itself may be scraped, and powder dust deteriorates indoor air environment.

A removal liquid for removing the gel nail contains an organic solvent. Therefore, the method for removing the gel nail using the removal liquid has problems such as generating offensive odor, deteriorating the indoor air environment, and inducing allergy depending on predisposition.

For example, these problems burden both a nail salon and a customer with psychological, physical, and temporal loads during a treatment at the nail salon. According to such findings, the inventors of the present invention have come to constitute the subject matter of the present disclosure. Therefore, the present disclosure provides a technique useful for removing the gel nail.

Hereinafter, an exemplary embodiment will be described in detail with reference to the accompanying drawings. However, unnecessary detailed description may be omitted. For example, detailed descriptions of already well-known matters or redundant descriptions of substantially the same configuration may be omitted. This is to avoid an unnecessary redundancy in the following description and to facilitate understanding of those skilled in the art.

Note that the accompanying drawings and the following description are only presented to help those skilled in the art fully understand the present disclosure, and are not intended to limit the subject matters described in the scope of claims.

### Exemplary Embodiment

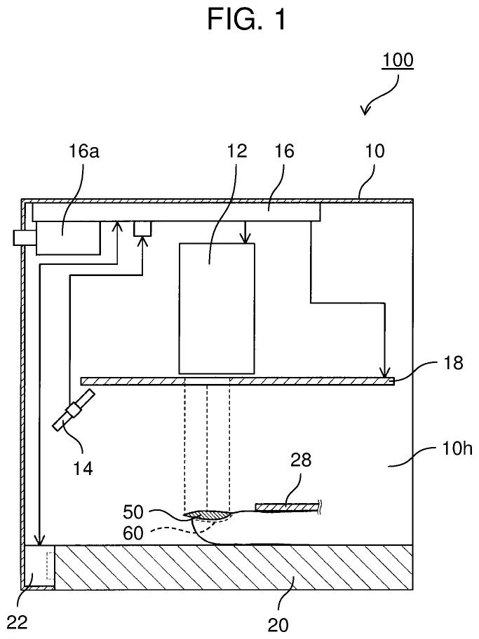

An exemplary embodiment will be described below with reference to FIGS. 1 to 7.

### [1-1. Configuration]

FIG. 1 is a configuration diagram of gel nail device 100 according to an exemplary embodiment. Gel nail device 100 includes stimulus generator 12, sensor 14, and control circuit 16. Stimulus generator 12, sensor 14, and control circuit 16 are housed in housing 10. Housing 10 has inner space 10h for placing a hand or a foot of a subject. Gel nail device 100 is a device that assists the steps of removing gel nail 50 from nail 60 of the subject.

Nail 60 of the subject may be the nail of the hand or the nail of the foot. Nail 60 of the subject may be the nail coated with a material such as resin. In the present description, the term “nail” includes both the nail itself and the nail coated with the material such as the resin.

The method for measuring an adhesion strength between gel nail 50 and nail 60 is not particularly limited. The adhesion strength may be a strength measured by a known method such as a tensile test, a scratch test, or the like.

Stimulus generator 12 applies an external stimulus to at least one of gel nail 50 or nail 60 to reduce the adhesion strength between gel nail 50 and nail 60. Sensor 14 detects at least one item selected from the group consisting of a position of gel nail 50, a state of gel nail 50, a position of nail 60, and a state of nail 60. Control circuit 16 controls stimulus generator 12 based on a detection result of sensor 14. When gel nail device 100 of the present exemplary embodiment is used, the adhesion strength between gel nail 50 and nail 60 is reduced by the external stimulus. Thus, the time spent in the steps of removing gel nail 50 from nail 60 can be shortened. As a result, in the nail salon, a customer satisfaction level is improved, and a profit of the nail salon is also improved.

Gel nail device 100 has a potential to remove gel nail 50 from nail 60 without the use of polishing tools and/or the organic solvents. When the polishing tool and/or the organic solvent is not used, it is possible to reduce the load burdened to nail 60, avoid nail 60 from being scraped, and maintain the indoor air environment well. Even in a case of using the polishing tool and/or the organic solvent, the load on nail 60 can be minimized, or an amount of the organic solvent used can be minimized.

Stimulus generator 12 generates at least one selected from the group consisting of light, heat, magnetic force, and electricity. That is, the external stimulus is at least one selected from the group consisting of the light, the heat, the magnetic force, and the electricity. By using these external stimuli, direct damage to nail 60 of the subject is less likely to occur. Typically, the external stimulus is applied only to gel nail 50. In this case, an influence of the external stimulus on a biological tissue such as nail 60 and skin can be minimized. The finger of the subject may be covered with shielding plate 28 so that only the portion of nail 60 is exposed.

When the external stimulus is the light, stimulus generator 12 includes a light source. When the external stimulus is the heat, stimulus generator 12 includes a heater or an infrared-light irradiation device. When the external stimulus is the magnetic force, stimulus generator 12 includes a magnetic field generator. When the external stimulus is the electricity, stimulus generator 12 includes a current source capable of supplying a weak current or a voltage source capable of supplying a weak voltage.

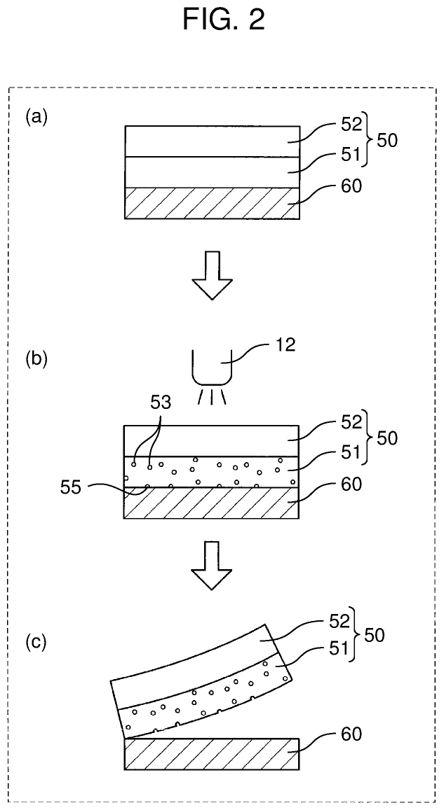

FIG. 2 is a schematic cross-sectional view for explaining a principle of reduction in the adhesion strength between gel nail 50 and nail 60. As illustrated in part (a) of FIG. 2, gel nail 50 has base coat 51 and gel nail body 52. Base coat 51 is a layer in contact with nail 60 of the subject. Gel nail body 52 is a layer formed on base coat 51, and is formed in a desired design using a color gel. Gel nail body 52 may be covered with a top coat. Gel nail 50 may be composed of a single layer.

A type of external stimulus depends on material contained in gel nail 50, specifically, material contained in base coat 51. When base coat 51 contains material that reduces the adhesion strength between gel nail 50 and nail 60 in response to the external stimulus, gel nail device 100 can be used to reduce the adhesion strength between gel nail 50 and nail 60. Hereinafter, the “material that reduces the adhesion strength” is also referred to as a “stimulus-responsive material”.

The stimulus-responsive material may be the material that undergoes a volume change by the external stimulus. The stimulus-responsive material may be the material that causes at least one selected from the group consisting of a physical property change and a chemical reaction by the external stimulus. Examples of the change in physical properties include vaporization, sublimation, a change in density, liquefaction, the change in elastic modulus, the change in viscoelasticity, and the like. Examples of the chemical reaction include a reaction accompanied by the change in molecular structure (cyclization, substitution, addition, etc.), a decomposition reaction, and the like. The stimulus-responsive material may be the material that generates gas due to the chemical reaction, sublimation, or the like caused by the external stimulus. The gas is generated and the volume change occurs. The stimulus-responsive material may be the material that reduces a contact area between gel nail 50 and nail 60 in response to the external stimulus. For example, the material that generates bubbles 53 in response to the external stimulus may be used as the stimulus-responsive material. As illustrated in part (b) of FIG. 2, bubbles 53 are also generated at interface 55 between base coat 51 and nail 60 to reduce the contact area between base coat 51 and nail 60 substantially. As a result, as illustrated in part (c) of FIG. 2, the adhesion strength between gel nail 50 and nail 60 is reduced, and gel nail 50 can be easily removed from nail 60.

Typically, the external stimulus is the light having a specific wavelength. In this case, stimulus generator 12 includes at least one light source. The light as the external stimulus can be applied to at least one of gel nail 50 or nail 60 in a pinpoint manner. Therefore, the influence of light on another biological tissues such as skin can be minimized. Examples of the light source include a laser light source, a light-emitting diode (LED) light source, a xenon flash lamp, an ultraviolet lamp, an infrared lamp, a near-infrared lamp, and the like. Hereinafter, in the present description, the at least one of gel nail 50 or nail 60 is also referred to as an “object”. The wavelength of the light is not particularly limited. The wavelength of light is selected depending on the material of gel nail 50. The light as the external stimulus may have the wavelength other than visible light, infrared light, and ultraviolet light. The light as the external stimulus may be an electromagnetic wave having a microwave wavelength. In this case, stimulus generator 12 includes an electromagnetic wave generator such as a microwave generator as the light source. Infrared or near-infrared light lamps may also be used when the external stimulus is the heat.

Base coat 51 contains, for example, a photocurable resin, a photopolymerization initiator, and the stimulus-responsive material. The photocurable resin is a main component of base coat 51. Examples of the photocurable resin include acrylic resins and epoxy resins. The “main component” means a component contained most in mass ratio. The photopolymerization initiator is the material for initiating a polymerization reaction when a raw material monomer or a raw material oligomer of the photocurable resin is irradiated with the light. Typically, the photopolymerization initiator is a radical polymerization initiator. Examples of the stimulus-responsive material include azide compounds such as glycidyl azide polymers, azo compounds, and the like. The azide compound is an organic or inorganic compound having an azide group, and decomposes to generate nitrogen gas. In this case, bubbles 53 are derived from nitrogen gas. The azo compound is an organic or inorganic compound having an azo group, and decomposes to generate nitrogen gas.

The at least one light source includes an ultraviolet light source that emits the ultraviolet light. When the azide compound and/or the azo compound is irradiated with the ultraviolet light, the nitrogen gas is generated. When stimulus generator 12 includes the ultraviolet light source, the azide compound and/or the azo compound contained in gel nail 50 (in particular, base coat 51) can be irradiated with the ultraviolet light to efficiently generate bubbles 53. As a result, the adhesion strength between gel nail 50 and nail 60 decreases.

A peak wavelength of the ultraviolet light is, for example, in a range from 280 nm or more to 350 nm or less. The azide compound and/or the azo compound generate the nitrogen gas in response to the ultraviolet light having the relatively short wavelength. By using the light having the peak wavelength in the range from 280 nm or more to 350 nm or less as the external stimulus, bubbles 53 can be efficiently generated. As a result, the adhesion strength between gel nail 50 and nail 60 decreases.

The external stimulus may be the heat. Examples of the stimulus-responsive material that causes the volume change when the heat is applied include (I) low-boiling point materials such as petroleum ether, pentane, hexane, heptane, fatty acid hydrocarbon, methylsilane, and halogen hydrocarbon, and (II) thermally decomposable foamable materials such as azo compounds, hydrazine derivatives, nitroso compounds, azide compounds, tetrazole compounds, semicarbazide compounds, carbonates, and bicarbonates. For example, the foamable material may be encapsulated in a thermoplastic resin such as (meth) acrylic acid ester, acrylonitrile, and vinylidene chloride in order to prevent volatilization of the stimulus-responsive material at a room temperature and to be stably dispersed in base coat 51. As the stimulus-responsive material that causes the volume change, a shape memory polymer having a characteristic that the volume is different above and below the glass transition point may be used. Examples of such shape memory polymer include a polyurethane-based shape memory polymer whose volume expands when heated to the glass transition point or higher.

For the stimulus-responsive material, near-infrared light and/or the infrared light may be used as the external stimulus, and the volume change may be caused by application of these lights. By increasing a temperature of gel nail 50 (in particular, base coat 51) using the near-infrared light and/or the infrared light, the stimulus-responsive material may undergo the volume change due to the heat. Materials that are likely to absorb the near-infrared light and/or the infrared light may be added to the material of gel nail 50 (base coat agent). As a result, by applying the near-infrared light and/or the infrared light, an effect of further increasing the temperature of gel nail 50 may be obtained.

Examples of the material that absorbs the near-infrared light and/or the infrared light to increase the temperature include a cyanine compound, a phthalocyanine compound, a naphthalocyanine-based compound, a porphyrin derivative, a naphthoquinone compound, an anthraquinone-based compound, a squarylium-based compound, an immonium compound, a diimmonium compound, a triallylmethane-based compound, an azo compound, a dithiol metal complex, carbon, and gold. These materials may have a form of nanoparticles.

A content ratio of the stimulus-responsive material in base coat 51 is, for example, 0.5 vol % or more, and may be 0.9 vol % or more. When the content ratio of the stimulus-responsive material is 0.5 vol % or more, for example, the stimulus-responsive material can be present in an area of 0.5% or more of an adhesion portion between gel nail 50 and nail 60. As a result, when the external stimulus is applied, gel nail 50 (base coat 51) may change in volume in the area of 0.5% or more of the adhesion portion between gel nail 50 and nail 60. Therefore, when the external stimulus is applied, the adhesion strength between gel nail 50 and nail 60 can be effectively reduced, and gel nail 50 can be more easily peeled off from nail 60. An upper limit of the content ratio of the stimulus-responsive material in base coat 51 is not particularly limited, and may be 100 vol % or less or 50 vol % or less. The content ratio of the stimulus-responsive material in base coat 51 can be specified by chemical analysis such as nuclear magnetic resonance (NMR), infrared spectroscopy (IR), mass spectrometry (MS), secondary ion mass spectrometry (SIMS), inductively coupled plasma mass spectrometry (ICP-MS), scanning electron microscopy (SEM), scanning electron microscopy-energy dispersive X-ray spectrometry (SEM-EDX), liquid chromatography, and spectrophotometry.

The wavelength of the ultraviolet light for curing the photocurable resin such as the acrylic resins or the epoxy resins is, for example, 365 nm or 405 nm. The peak wavelength of the ultraviolet light for promoting the decomposition reaction of the azide compound and/or the azo compound is in the range from 280 nm or more to 350 nm or less. By using the resin that cures with the ultraviolet light having the peak wavelength in the range longer than 350 nm as the photocurable resin as the main component of gel nail 50, it is possible to avoid the decomposition of the azide compound and/or the azo compound when forming gel nail 50.

That is, stimulus generator 12 may be configured to emit a plurality of types of lights having the peak wavelengths different from each other. For example, the peak wavelength of a first light is in the range from 360 nm or more to 410 nm or less, and the peak wavelength of a second light is in the range of 280 nm or more and less than 360 nm. For example, stimulus generator 12 has a plurality of light sources having the peak wavelengths different from each other. When gel nail device 100 is operated, either the first light or the second light is emitted from stimulus generator 12. In this case, when decorating nail 60 with gel nail 50, a photopolymerization reaction of the raw material monomer or the raw material oligomer of gel nail 50 is caused using the first light. The second light is used to decompose the azide compound and/or the azo compound when removing gel nail 50. According to such configuration, gel nail device 100 can be used not only for removing gel nail 50 but also for decorating nail 60 with gel nail 50. The peak wavelength of the second light may be 350 nm or less.

Control circuit 16 is a computer unit including a processor, a memory, an input/output interface, a communication module, and the like. Such computer units include Raspberry Pi (registered trademark), Arduino (registered trademark), systems customized based thereon, and the like. The memory stores a program for operating gel nail device 100. The memory may include a work area of the program executed by the processor. Examples of the input/output interface include a serial interface such as RS-232C, USB, and HDMI.

Gel nail device 100 may include transmission/reception unit 16a that transmits data to the outside and receives data from the outside. Such transmission/reception unit 16a may be the above-described input/output interface, may be a wireless LAN module, may be a Wi-Fi (registered trademark) module, or may be a short-range wireless communication module such as Bluetooth (registered trademark). Gel nail device 100 may be connectable to the Internet via transmission/reception unit 16a. Transmission/reception unit 16a may be mounted on control circuit 16 or may be another circuit module communicably connected to control circuit 16. Control circuit 16 may receive information transmitted from an external communication terminal via transmission/reception unit 16a and control the operation of devices such as stimulus generator 12 according to the received information. That is, gel nail device 100 may be configured to operate in response to external commands. In this case, it is not necessary to provide an input unit such as a touch panel in gel nail device 100.

Control circuit 16 controls stimulus generator 12 based on a detection result of sensor 14. Specifically, control circuit 16 adjusts application conditions of the external stimulus by controlling stimulus generator 12. As a result, it is possible to apply the external stimulus to gel nail 50 and/or nail 60 so that the adhesion strength between gel nail 50 and nail 60 is more reliably reduced while minimizing the influence of the external stimulus on the biological tissue such as nail 60 and the skin.

The application conditions of the external stimulus include at least one selected from the group consisting of a target region to which the external stimulus is to be applied, time (length of time) to which the external stimulus is to be applied, and an intensity of the external stimulus. For example, when the external stimulus is the light, control circuit 16 adjusts at least one of the target region to be irradiated with the light, the time to be irradiated with the light, and the intensity of the light. When the external stimulus is the heat, control circuit 16 adjusts at least one of the target region to which the heat is to be applied, the time to which the heat is to be applied, and the intensity of the heat (temperature). As a result, it is possible to apply the external stimulus to gel nail 50 and/or nail 60 so that the adhesion strength between gel nail 50 and nail 60 is more reliably reduced while minimizing the influence of the light on biological tissue such as nail 60 and the skin.

For example, sensor 14 includes at least one image sensor. The image sensor creates at least one image selected from the group consisting of gel nail 50 and nail 60. The image represents the position of gel nail 50 and/or the position of nail 60. The image may be a two-dimensional image. Control circuit 16 acquires the image from sensor 14, and adjusts application conditions of the external stimulus with reference to the acquired image. For example, if the acquired image is analyzed by a known image recognition technology, the region of the object can be accurately specified. The specified region is recognized as the target region to which the external stimulus is to be applied. Control circuit 16 controls stimulus generator 12 so that the external stimulus is applied to the target region. As a result, it is possible to avoid the application of the external stimulus to the portion other than the object. The region of the object may be the region on two-dimensional coordinates or the region on three-dimensional coordinates. By using a plurality of (for example, three) image sensors, it is possible to specify the region on the three-dimensional coordinates.

As illustrated in FIG. 1, gel nail device 100 further includes mask 18. Mask 18 is disposed between the light source as stimulus generator 12 and nail 60 provided with gel nail 50. An irradiation range of the light as the external stimulus is specified by mask 18. According to such configuration, it is possible to effectively prevent the portion other than the object from being irradiated with the light.

In the present exemplary embodiment, mask 18 is an electronic mask. For example, mask 18 includes a transparent display. A predetermined mask image is displayed on the transparent display. The mask image may be a binarized image in which the region where light transmission is to be permitted and the region where the light transmission is to be prohibited are distinguished in transparent and black, respectively. Control circuit 16 controls mask 18 so that only the target region is irradiated with the light. According to such configuration, it is possible to prevent the portion other than the object from being irradiated with the light more effectively.

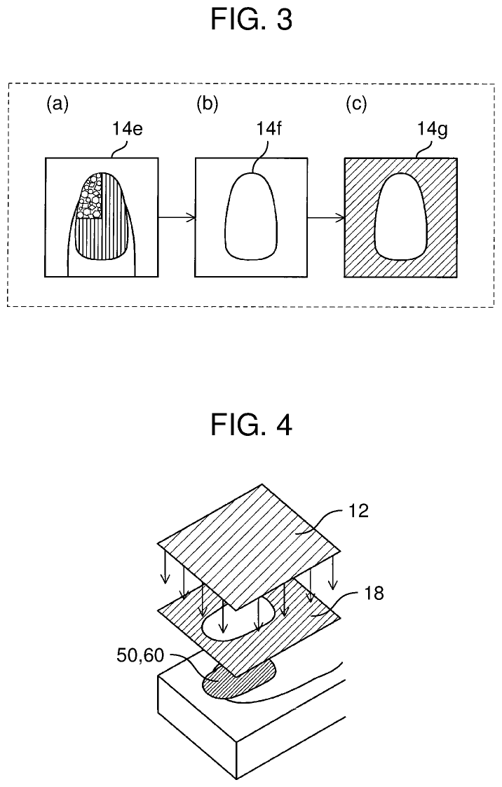

FIG. 3 is a diagram illustrating the method of generating the mask image used for controlling mask 18. FIG. 4 is a diagram illustrating the light irradiation using mask 18. As illustrated in part (a) of FIG. 3, image 14e of the object to which the external stimulus is to be applied, i.e., the image of gel nail 50 and/or nail 60, is sent from sensor 14 to control circuit 16. Next, as illustrated in part (b) of FIG. 3, control circuit 16 extracts contour 14f of the object from image 14e by image processing. Then, as illustrated in part (c) of FIG. 3, mask image 14g for controlling mask 18 is generated with reference to contour 14f of the object. Control circuit 16 controls mask 18 using mask image 14g. As a result, as illustrated in FIG. 4, mask 18 is controlled such that the light is transmitted only through the region corresponding to the target region, and the object is appropriately irradiated with the light. According to such configuration, it is possible to effectively prevent the portion other than the object from being irradiated with the light.

The acquisition of image 14e may be periodically performed to update the target region in real time, for example, in a short time period in seconds. In one example, the acquisition of image 14e, the generation of mask image 14g, and the update of mask 18 may be periodically performed. In this way, even if the hand or the foot slightly moves inside housing 10, the change in the coordinates of the target region can be captured in real time. As a result, the external stimulus can be more reliably applied to the target region.

Gel nail device 100 may further include a machine learning module that learns to specify application conditions of the external stimulus. According to such configuration, application conditions of the external stimulus can be appropriately specified. Specifically, in order to accurately specify contour 14f of gel nail 50, gel nail device 100 may include the machine learning module that learns image 14e of gel nail 50. The machine learning module may be implemented in control circuit 16 or may be implemented in an extension cartridge described later. Furthermore, the machine learning module may be implemented in a server communicatively connected to gel nail device 100 via a communication network such as the Internet.

The design, dimensions, and shape of gel nail 50 are abundant, and it may be difficult to specify contour 14f of gel nail 50 by the image recognition. The images of various types of known gel nails 50 are provided to the machine learning module as training data to learn for specifying contours 14f of gel nails 50. That is, the machine learning module is trained to specify the light irradiation area (application conditions of the external stimulus). The machine learning module determines whether image 14e acquired from sensor 14 is the object (gel nail 50) and specifies its contour 14f. For example, contour 14f is created in the form of a set of points on the two-dimensional coordinates. According to such configuration, contour 14f of gel nail 50 can be specified with high accuracy. In one example, a convolution neural network (CNN) method is suitable for the present exemplary embodiment. Image 14e acquired by sensor 14 may be used as the training data.

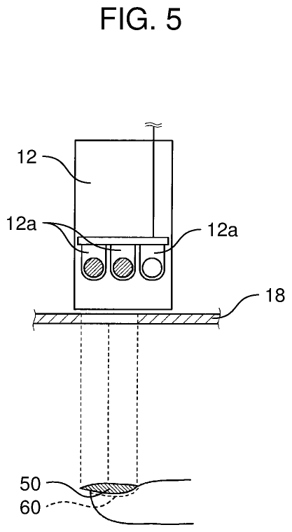

FIG. 5 is a configuration diagram of the light source as stimulus generator 12. Stimulus generator 12 has a plurality of light sources 12a. For example, the plurality of light sources 12a are arranged in a planar and matrix shape. Each of light sources 12a may be a point light source. Control circuit 16 determines the irradiation range of the light as the external stimulus by turning on and off each of the plurality of light sources 12a. That is, each of the plurality of light sources 12a is turned on or off so that only the target region is irradiated with the light. With such configuration, it is also possible to prevent the portion other than the object from being irradiated with the light.

When the plurality of light sources 12a is used, mask 18 may be omitted. Combinations of the plurality of light sources 12a and the mask 18 may also be preferably employed. Mask image 14g described with reference to part (c) of FIG. 3 can also be used to control turning on and off of the plurality of light sources 12a.

Instead of the plurality of light sources 12a and mask 18, stimulus generator 12 may include a laser light source and a galvano scanner. Control circuit 16 controls the galvano scanner such that only the target region is irradiated with the laser beam. In this case, it is also possible to reliably prevent the portion other than the object from being irradiated with the light.

In addition, a shutter physically driven by an actuator such as a motor may be used instead of mask 18. The physically driven shutter is configured to shield portions other than the nails of the subject's hand or foot.

When sensor 14 includes the image sensor, the image sensor may be a line sensor. In this case, the position of the distal end of gel nail 50, the position of the distal end of nail 60, and the like can be specified by the line sensor.

Sensor 14 may include a temperature sensor. The temperature sensor detects the temperature of at least one selected from the group consisting of gel nail 50 and nail 60. The detected temperature indicates the state of gel nail 50 and/or the state of nail 60. Control circuit 16 adjusts the application conditions of the external stimulus with reference to the detected temperature and temporal changes in the temperature. For example, when the decomposition reaction of the stimulus-responsive material contained in base coat 51 proceeds, the heat is generated. Therefore, a degree of progress of the decomposition reaction of the stimulus-responsive material can be estimated from the detected temperature and/or the temporal changes in the detected temperature. When it is determined that the decomposition reaction proceeds sufficiently, control circuit 16 controls stimulus generator 12 to stop the irradiation of the ultraviolet light. When the decomposition reaction does not proceed, control circuit 16 controls the stimulus generator 12 to continue the irradiation of the ultraviolet light. When the decomposition reaction does not proceed sufficiently, control circuit 16 may control stimulus generator 12 to increase the intensity of the ultraviolet light (unit: mW/cm²). In this way, not only the time spent in the steps for reducing the adhesion strength can be significantly shortened, but also an excessive application of the ultraviolet light as the external stimulus can be avoided.

As described above, control circuit 16 acquires the information regarding the object from sensor 14, and stores and analyzes the acquired information. Control circuit 16 controls devices such as stimulus generator 12 based on the analysis result. For example, when sensor 14 includes the image sensor, control circuit 16 receives the image from sensor 14 and specifies the region of gel nail 50 and/or the region of nail 60. The light source as stimulus generator 12 and mask 18 are controlled so that the specified region (target region) is irradiated with the light.

As shown in FIG. 1, gel nail device 100 may further include extension cartridge 20. Extension cartridge 20 has additional or alternative components such as another sensor and another control circuit, and is used to change the operation of gel nail device 100. Extension cartridge 20 is replaceable. By using extension cartridge 20, a control program of gel nail device 100 can be updated, or a new function can be added to gel nail device 100. In the present exemplary embodiment, extension cartridge 20 constitutes a part of housing 10. Specifically, a bottom portion of housing 10 is configured by extension cartridge 20.

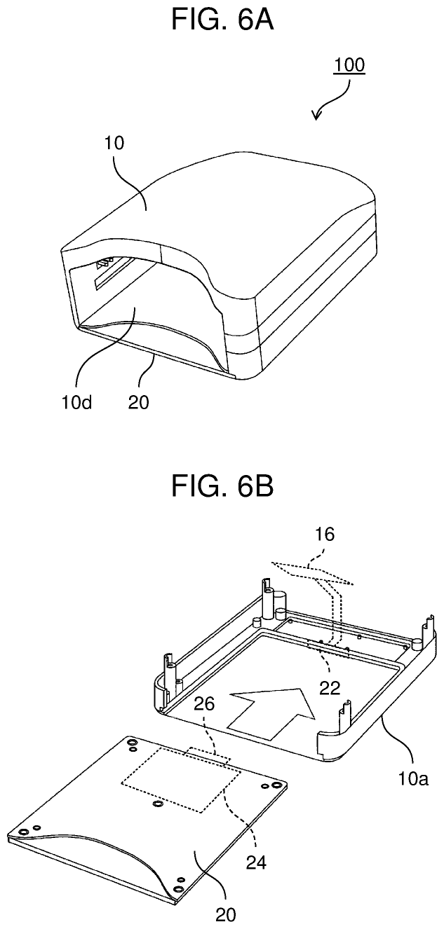

FIG. 6A is a perspective view of gel nail device 100. FIG. 6B is a perspective view of a housing lower portion. As illustrated in FIG. 6A, housing 10 has opening 10d on the front for inserting the subject's hand or foot. As illustrated in FIG. 6B, extension cartridge 20 is fitted to housing lower portion 10a and functions as a stage for placing the hand or the foot. The back surface or inside of extension cartridge 20 as component 24 for function extension has an integrated circuit and/or an extension device. Housing lower portion 10a has connection terminal 22. Connection terminal 22 at housing lower portion 10a and connection terminal 26 of extension cartridge 20 are connected to each other. As a result, extension cartridge 20 is attached to housing 10 and electrically connected to control circuit 16.

Housing 10 may be configured by combining a plurality of components such as a housing upper portion, a housing side portion, and an inner chassis in addition to housing lower portion 10a and extension cartridge 20.

### [1-2. Operation]

Operation of gel nail device 100 configured as described above will be described below.

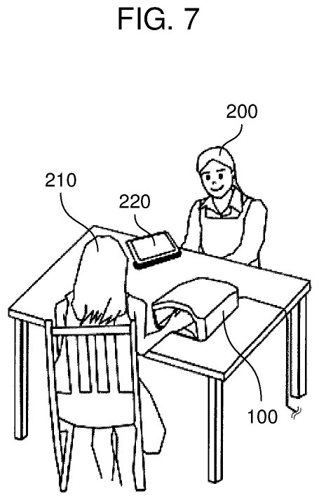

FIG. 7 is a diagram illustrating an appearance of a treatment using the gel nail device 100. The hand of subject 210 such as the customer is inserted into gel nail device 100 to facilitate the removal of gel nail 50 from nail 60. Practitioner 200 such as a manicurist directly operates gel nail device 100 or indirectly operates gel nail device 100 using communication terminal 220 such as a smartphone or a tablet to start the treatment by gel nail device 100. The treatment includes the steps for reducing the adhesion strength between gel nail 50 and nail 60.

First, nail data regarding the position of gel nail 50 and the like is acquired by sensor 14 in gel nail device 100. Control circuit 16 refers to the nail data and applies the external stimulus for reducing the adhesion strength between gel nail 50 and nail 60 to at least one of gel nail 50 and nail 60. Gel nail 50 is easily peeled off from nail 60 by applying the external stimulus. Control circuit 16 automatically stops the application of the external stimulus and notifies that the treatment has ended. Practitioner 200 actually removes gel nail 50 from nail 60 using a peeler. Thus, the steps of removing gel nail 50 from the nail is completed.

### [1-3. Effects, Etc.]

As described above, in the present exemplary embodiment, gel nail device 100 includes: stimulus generator 12 applying the external stimulus for reducing the adhesion strength between gel nail 50 and nail 60 to at least one of the gel nail or the nail; sensor 14 detecting at least one item selected from the group consisting of the position of gel nail 50, the state of gel nail 50, the position of nail 60, and the state of nail 60; and control circuit 16 controlling stimulus generator 12 based on the detection result from sensor 14.

According to such configuration, the adhesion strength between gel nail 50 and nail 60 is reduced by the external stimulus. Thus, the time spent in the steps of removing gel nail 50 from nail 60 can be shortened. As a result, for example, the customer satisfaction level is improved in the nail salon, and the profit of the nail salon is also improved.

In the present exemplary embodiment, control circuit 16 may adjust the application conditions of the external stimulus by controlling stimulus generator 12. According to such configuration, the external stimulus can be applied to gel nail 50 and/or nail 60 so that the adhesion strength between gel nail 50 and nail 60 is reliably reduced while minimizing the influence of the external stimulus on the biological tissue such as nail 60 and the skin.

In the present exemplary embodiment, the application conditions of the external stimulus may include at least one selected from the group consisting of the target region to which the external stimulus is to be applied, the time to which the external stimulus is to be applied, and the intensity of the external stimulus. According to such configuration, the external stimulus can be applied to gel nail 50 and/or nail 60 so that the adhesion strength between gel nail 50 and nail 60 is reliably reduced while minimizing the influence of the external stimulus on the biological tissue such as nail 60 and the skin.

In the present exemplary embodiment, sensor 14 may include the image sensor. According to such configuration, at least one image selected from the group consisting of gel nail 50 and nail 60 can be acquired.

In the present exemplary embodiment, the image sensor may create the at least one image selected from the group consisting of gel nail 50 and nail 60. Control circuit 16 may adjust the application conditions of the external stimulus with reference to the image. According to such configuration, it is possible to avoid the application of the external stimulus to the portion other than the target object.

In the present exemplary embodiment, sensor 14 may include the temperature sensor. According to such configuration, the temperature of at least one selected from the group consisting of gel nail 50 and nail 60 can be detected.

In the present exemplary embodiment, the temperature sensor may detect the temperature of at least one selected from the group consisting of gel nail 50 and nail 60. Control circuit 16 may adjust the application conditions of the external stimulus with reference to the temperature and the temporal changes in the temperature. According to such configuration, it is possible not only to significantly shorten the time spent in the steps for reducing the adhesion strength but also to avoid the excessive application of the external stimulus.

In the present exemplary embodiment, stimulus generator 12 may generate at least one selected from the group consisting of the light, the heat, the magnetic force, and the electricity as the external stimulus. By using these external stimuli, direct damage to nail 60 of the subject is less likely to occur.

In the present exemplary embodiment, stimulus generator 12 may include at least one light source. According to such configuration, the influence of the light on another biological tissues such as skin can be minimized.

In the present exemplary embodiment, the at least one light source may include the ultraviolet light source that emits the ultraviolet light. According to such configuration, it is possible to efficiently generate bubbles 53 by irradiating the stimulus-responsive material contained in gel nail 50 with the ultraviolet light.

In the present exemplary embodiment, the peak wavelength of the ultraviolet light may be in the range from 280 nm or more to 350 nm or less. According to such configuration, bubbles 53 can be efficiently generated.

In the present exemplary embodiment, the at least one light source may include the plurality of light sources. Control circuit 16 may determine the irradiation range of the light as the external stimulus by turning on and off each of the plurality of light sources. According to such configuration, it is possible to prevent the portion other than the object from being irradiated with the light.

In the present exemplary embodiment, gel nail device 100 may further include mask 18 located between the at least one light source and nail 60 provided with gel nail 50. The irradiation range of the light as the external stimulus may be determined by mask 18. According to such configuration, it is possible to more reliably prevent the portion other than the object from being irradiated with the light.

In the present exemplary embodiment, gel nail device 100 may further include the memory that stores data related to nail 60 of the subject. Control circuit 16 may control stimulus generator 12 based on the sensing result of sensor 14 and the data stored in the memory. According to such configuration, complicated image processing can be avoided. In the present exemplary embodiment, gel nail device 100 may further include the machine learning module that learns to specify the application conditions of the external stimulus. According to such configuration, application conditions of the external stimulus can be appropriately specified.

In the present exemplary embodiment, the training data provided to the machine learning module may include the image data of gel nail 50. According to such configuration, contour 14f of gel nail 50 can be specified with high accuracy.

In the present exemplary embodiment, gel nail device 100 may further include extension cartridge 20 having additional or alternative components. Extension cartridge 20 may be replaceable. According to such configuration, the control program of gel nail device 100 can be updated, or the new function can be added to gel nail device 100.

In the present exemplary embodiment, gel nail device 100 may further include transmission/reception unit 16a that transmits data to the outside and receives data from the outside. According to such configuration, it is not necessary to provide the input unit such as the touch panel in gel nail device 100.

### Other Exemplary Embodiments

As described above, the exemplary embodiment has been described as an example of the technique disclosed in the present application. However, the techniques of the present disclosure are not limited thereto, but may be applicable to exemplary embodiments with changes, additions, omissions, or the like. Alternatively, the components described in the above exemplary embodiment may be combined to make an additional exemplary embodiment.

Hereinafter, other exemplary embodiments are thus exemplified.

Gel nail device 100 can also be used in the steps of decorating the nail of the subject with gel nail 50. Specifically, gel nail device 100 may be used in the step of applying a base coating agent to the nail, may be used in the step of curing the applied base coating agent, or may be used in both steps.

A plurality of sensors such as the image sensor and the temperature sensor may be provided as sensor 14. In addition to the image sensor and the temperature sensor, sensor 14 may include at least one of a humidity sensor, an optical sensor, a resistivity meter, an ultrasonic sensor, a pressure sensor, and a proximity sensor. According to these sensors, it is possible to measure various characteristic amounts such as the image, the temperature, humidity, electric resistance, sound wave, light (intensity of reflected light and/or transmitted light), and strength of force. By combining the image sensor and these sensors, various data regarding the nail and the skin of the subject can be acquired. The acquired data is sent to control circuit 16 and used to control the devices such as stimulus generator 12.

The memory of control circuit 16 may store the data regarding nail 60 of the subject such as the customer. For example, the data related to nail 60 is two-dimensional or three-dimensional image data of nail 60 of the subject, and is stored in advance in the memory together with the ID of the subject. In this case, control circuit 16 may control stimulus generator 12 based on the sensing result of sensor 14 and the image data of nail 60 stored in the memory. For example, the light irradiation region is determined using the image data of nail 60 of the subject, and the light irradiation time is determined using the detection result of the temperature sensor as sensor 14. In this way, the complicated image processing can be avoided. Examples of the ID of the subject include a name of the subject, an identification number assigned to the subject, and the like.

Using a projector module, a specific pattern image such as a moire pattern, a random pattern, and a lattice pattern is projected on the nail, and the projected image is captured by sensor 14. By analyzing distortion of the obtained image, three-dimensional shape data of nail 60 is acquired. This three-dimensional shape data can be used for 3D printing of nail tips optimized for the shape of nail 60 of the subject. Alternatively, the three-dimensional shape data may be fed back to the subject as diagnosis data of unevenness of the skin.

If extension cartridge 20 is used, the sensor or the like that is not mounted on gel nail device 100 in advance can be mounted as an extension function. Furthermore, extension cartridge 20 may have a reference structure that defines a reference position of the finger or a toe. Examples of the reference structure include a jig for fixing the finger or the toe, a recess capable of accommodating the finger or the toe, a handle capable of being grasped by the hand, a hand grip rod capable of being grasped by the hand, and the like. A plurality of types of extension cartridges may be prepared such as the extension cartridge dedicated to the treatment of the hand and the extension cartridge dedicated to the treatment of the foot. In this case, the extension cartridge can be replaced and used according to contents of the treatment.

Control circuit 16 may be configured to store and manage the ID of the subject and the feature quantity detected from the subject being associated each other in an internal memory or a communication destination server. Accordingly, it is possible to accumulate and manage the data such as the image of the subject, the feature quantity possessed by the subject, and a treatment history of the subject. These data may be not only browsed by the subject as his/her own treatment history but also shared by practitioner 200. This helps to inform practitioner 200 of the design of gel nail 50 desired by the subject such as the customer. Furthermore, gel nail device 100 can be operated so that the light suitable for a skin condition of the subject is emitted. Examples of the skin condition of the subject include brightness of the skin, the unevenness of the skin, and color tone of the skin.

Control circuit 16 may be configured to record the time spent in the steps for reducing the adhesion strength between gel nail 50 and nail 60 in the memory or an external server. The required time may be the time required from the start of the steps for reducing the adhesion strength between gel nail 50 and nail 60 to completion of electronic payment of a service fee. The information regarding the required time is useful information for the nail salon.

Data of application conditions of the external stimulus may be transmitted and received between the outside and gel nail device 100 via transmission/reception unit 16a. According to such configuration, there is a possibility that application conditions of the external stimulus can be quickly determined.

Through transmission/reception unit 16a, transmission and reception of data regarding a situation of the treatment or the situation of the subject to be treated may be performed between the outside and gel nail device 100. According to such configuration, there is the possibility of avoiding the excessive application of the external stimulus. The “treatment” includes the steps for reducing the adhesion strength between gel nail 50 and nail 60.

Gel nail device 100 may be configured to be able to control the operation from the outside. Control data necessary for controlling the operation may be transmitted and received via transmission/reception unit 16a. According to such configuration, it is possible to provide gel nail device 100 having excellent operability and expandability. Since it is not essential to provide the input unit such as the touch panel in gel nail device 100, it is possible to provide gel nail device 100 having a simple and sophisticated design.

A target to be treated may include the skin around nail 60 in addition to nail 60.

Gel nail device 100 may include a material identification unit that identifies an appropriate stimulus-responsive material from application conditions of the external stimulus. According to such configuration, gel nail 50 suitable for each subject can be provided. The material identification unit can be configured by software executed in control circuit 16.

Gel nail device 100 may include a health assessment unit that assesses health condition of the subject from the state of the target to be treated. For example, the health condition of the subject can be determined from the color of nail 60, the temperature of nail 60, and the like. The health assessment unit can be configured by software executed in control circuit 16. The health assessment unit may include at least one of a thermometer that measures a body temperature of the subject in a non-contact manner, a camera that photographs a face of the subject, and a sphygmomanometer that measures a blood pressure of the subject.

Gel nail device 100 may include a material identification unit that identifies the stimulus-responsive material suitable for the subject from the health condition of the subject determined by the health assessment unit. According to such configuration, it is possible to provide gel nail 50 suitable for each subject such as the customer. The material identification unit can be configured by software executed in control circuit 16.

Gel nail device 100 may further include the camera (image sensor) that photographs the face of the subject such as a customer. Gel nail device 100 may have a material selection unit that selects the stimulus-responsive material suitable for the subject from a captured facial image. According to such configuration, gel nail 50 suitable for each subject can be provided. The material selection unit can be configured by software executed in control circuit 16.

One or more hand grips may be provided inside housing 10.

Gel nail device 100 of the present exemplary embodiment is suitable for use in the nail salon. However, gel nail device 100 can also be used at home.

Since the above described exemplary embodiments are intended to exemplify the technique according to the present disclosure, various modifications, replacements, additions, and omissions can be made within the scope of the appended claims or of their equivalents.

### INDUSTRIAL APPLICABILITY

The technology of the present disclosure is useful for gel nail treatment.

### REFERENCE MARKS IN THE DRAWINGS

10: housing
10a: housing lower portion
10d: opening
10h: inner space
12: stimulus generator
12a: light source
14: sensor
14e: image
14f: contour
14g: mask image
16: control circuit
16a: transmission/reception unit
18: mask
20: extension cartridge
22, 26: connection terminal
24: component
28: shielding plate
50: gel nail
51: base coat
52: gel nail body
53: bubbles
55: interface
60: nail
100: gel nail device
200: practitioner
210: subject
220: communication terminal

1. A gel nail device comprising:
a stimulus generator applying an external stimulus for reducing an adhesion strength between a gel nail and a nail to at least one of the gel nail or the nail;
a sensor detecting at least one item selected from the group consisting of a position of the gel nail, a state of the gel nail, a position of the nail, and a state of the nail; and
a control circuit controlling the stimulus generator based on a detection result from the sensor.

2. The gel nail device according to claim 1, wherein the control circuit adjusts application conditions of the external stimulus by controlling the stimulus generator.

3. The gel nail device according to claim 1, wherein application conditions of the external stimulus include at least one item selected from the group consisting of a target region to which the external stimulus is to be applied, time to which the external stimulus is to be applied, and an intensity of the external stimulus.

4. The gel nail device according to claim 1, wherein the sensor includes an image sensor.

5. The gel nail device according to claim 4, wherein the image sensor creates at least one image selected from the group consisting of the gel nail and the nail, and the control circuit adjusts application conditions of the external stimulus with reference to the image.

6. The gel nail device according to claim 1, wherein the sensor includes a temperature sensor.

7. The gel nail device according to claim 6, wherein the temperature sensor detects a temperature of at least one item selected from the group consisting of the gel nail and the nail, and the control circuit adjusts application conditions of the external stimulus with reference to the temperature and temporal changes in the temperature.

8. The gel nail device according to claim 1, wherein the stimulus generator generates at least one item selected from the group consisting of light, heat, magnetic force, and electricity as the external stimulus.

9. The gel nail device according to claim 1, wherein the stimulus generator includes at least one light source.

10. The gel nail device according to claim 9, wherein the at least one light source includes an ultraviolet light source emitting ultraviolet light.

11. The gel nail device according to claim 10, wherein a peak wavelength of the ultraviolet light is in a range from 280 nm or more to 350 nm or less.

12. The gel nail device according to claim 9, wherein the at least one light source includes a plurality of light sources, and the control circuit determines an irradiation range of light as the external stimulus by turning on and off each of the plurality of light sources.

13. The gel nail device according to claim 9, further comprising a mask positioned between the at least one light source and the nail provided with the gel nail,
wherein an irradiation range of light as the external stimulus is determined by the mask.

14. The gel nail device according to claim 1, further comprising a memory storing data pertaining to nails of customers,
wherein the control circuit controls the stimulus generator based on the detection result of the sensor and the data stored in the memory.

15. The gel nail device according to claim 1, further comprising a machine learning module that learns to specify application conditions of the external stimulus.

16. The gel nail device according to claim 15, wherein training data provided to the machine learning module includes image data of the gel nail.

17. The gel nail device according to claim 1, further comprising an extension cartridge having additional or alternative components,
wherein the extension cartridge is replaceable.

18. The gel nail device according to claim 1, further comprising a transmission and reception unit transmitting data to outside and receiving data from the outside.

19. A method for removing a gel nail from a nail, the method comprising the sequential steps of:
acquiring nail data of at least one item selected from the group consisting of a position of the gel nail, a state of the gel nail, a position of the nail, and a state of the nail;
referring the nail data and applying an external stimulus for reducing an adhesion strength between the gel nail and the nail to at least one of the gel nail and the nail; and
removing the gel nail from the nail.
